(19) United States
(12) Patent Application Publication
(10) Pub. No.: US 2021/0398194 A1
(43) Pub. Date: Dec. 23, 2021

(54) METHODS AND SYSTEMS FOR REDUCING MEMORY USAGE IN AN E-COMMERCE SYSTEM

(71) Applicant: Shopify Inc., Ottawa (CA)

(72) Inventors: Korosh Koochekian SABOR, Montreal (CA); Petra AXOLOTL, Saint-Bruno-de-Montarville (CA); Ganesh IYER, Toronto (CA)

(73) Assignee: Shopify Inc., Ottawa (CA)

(21) Appl. No.: 16/903,800

(22) Filed: Jun. 17, 2020

(51) Int. Cl. G06Q 30/06; G06F 9/451; G06F 9/54; G06N 20/00; G06Q 30/02

(52) U.S. Cl. CPC G06Q 30/0633; G06F 9/451; G06Q 30/02; G06N 20/00; G06F 9/542

(57) ABSTRACT

Methods and systems for reducing memory consumption due to abandoned data structures in an e-commerce platform. A shopping cart data structure contains at least one product item identifier and a user identifier. The platform determines a probability of completion associated with the shopping cart data structure based at least in part on the at least one product item identifier and the user identifier. If the probability of completion is lower than a threshold value, then the platform identifies a data change and applies the data change to the shopping cart data structure to produce a modified shopping cart data structure. A display on a user device is generated based on the modified shopping cart data structure. The data change selected to produce a modified shopping cart data structure that correlates to a higher probability of completion.

### FIELD

The present disclosure relates to computer-implemented e-commerce platforms and, in particular, to methods and systems for reducing memory consumption due to abandoned data structures.

### BACKGROUND

Over the past decade, online product retailing has become commonplace, to the point where a large percentage of merchants, whether big or small, make products available through an online store. In some cases, merchants may use a third party e-commerce platform that provides a centralized system to enable online resources and facilities for managing retail business. These platforms model the retail shopping experience for a user during an active session on the platform by providing a data structure as a “shopping cart”. As the user browses items made available by a particular merchant, the user is able to instruct the platform to add one or more items to their “shopping cart”. The platform saves data regarding the selected item and any optional parameters regarding the item to a shopping cart data structure associated with the user and the current session.

In many cases during a session with an on-line store, users cause shopping cart data structures to be created but do not complete the session to the point of a purchase. That is, the session is terminated before completion. In some cases, this is unintentional, such as when a user device loses connectivity with the on-line store, but in many cases it is intentional. Users may be comparison shopping, window shopping, re-thinking or re-evaluating decisions, building a cart into which they add items over time, etc. For various reasons, the e-commerce platform and merchants retain these abandoned shopping cart data structures in memory so that when the same user returns in a new session the platform and/or merchant may present them with the partially-completed shopping cart. Even without establishment of a new session, after a period of time the platform may prompt the user to return to the abandoned cart using a messaging or notification mechanism. Because it has become common for users to start sessions and abandon carts, significant memory resources on the platform are consumed by maintaining abandoned shopping cart data structures in memory. Moreover, shopping cart data structures may result in initiated processes or routines on the platform that, once the cart is abandoned, persist and result in problematic “noise”.

### BRIEF DESCRIPTION OF THE DRAWINGS

Embodiments will be described, by way of example only, with reference to the accompanying figures wherein:

FIG. 1 is a block diagram of an e-commerce platform, according to one embodiment;

FIG. 2 is an example of a home page of an administrator, according to one embodiment;

FIG. 3 shows, in block diagram form, one simplified example embodiment of an e-commerce platform;

FIG. 4 shows, in flowchart form, one example method of reducing memory consumption due to abandoned data structures in an e-commerce platform;

FIG. 5 shows a diagrammatic illustration of a system for determining a probability of completion; and

FIG. 6 shows, in flowchart form, another example method for reducing memory consumption due to abandoned data structures in an e-commerce platform.

### DETAILED DESCRIPTION

In one aspect, the present application describes computer-implemented method for processing shopping cart data structures. The method may include storing a shopping cart data structure in memory during an active session, the shopping cart data structure containing at least one product item identifier and a user identifier; determining a probability of completion associated with the shopping cart data structure based at least in part on the at least one product item identifier and the user identifier; determining that the probability of completion is lower than a threshold value and, as a result, identifying a data change, and applying the data change to the shopping cart data structure to produce a modified shopping cart data structure; and causing a display on a user device based on the modified shopping cart data structure.

In some implementations, the method may include detecting a trigger event prior to determining the probability of completion. In some cases, the trigger event may include receiving an input to initiate a checkout process. In some cases, the trigger event may include receiving an input causing a change in content of the shopping cart data structure. In some examples, the change in the content of the shopping cart data structure includes adding a further product item identifier to the shopping cart data structure.

In some implementations, determining the probability of completion is based on a probability model and the probability model has inputs that include the at least one product item identifier, the user identifier, and at least one of user history data or merchant history data. In some cases, the probability model is generated by a machine learning engine, and wherein the method further includes determining a completion result and providing the completion result to the machine learning engine to update the probability model.

In some implementations, identifying a data change includes selecting the data change from among a plurality of predefined data changes. In some cases, selecting includes determining a respective probability of completion associated with a modified shopping cart data structure for each of the plurality of predefined data changes and selecting the data change based on it having a highest associated respective probability of completion. In some cases, the plurality of predefined data changes includes a set of data changes filtered to exclude at least some data changes based on a merchant-defined restriction parameter.

In some implementations, applying the data change to the shopping cart data structure includes insertion of a new product item identifier, increase in a product item count, change in a product item parameter, change in a shipping cost parameter, or change in a loyalty points parameter.

In some implementations, identifying a data change includes determining a new probability of completion associated with the modified shopping cart data structure based at least in part on the at least one product item identifier, the user identifier, and the data change, and determining that the new probability of completion is greater than the probability of completion by at least a minimum value.

In some implementations, the method may include completing a transaction regarding the modified shopping cart data structure and, as a result, deleting the modified shopping cart data structure from the memory.

In another aspect, the present application describes a system for processing shopping cart data structures. The system may include a processor; and a storage medium storing computer-executable instructions. When executed by the processor, the instruction may cause the processor to store a shopping cart data structure in a memory during an active session, the shopping cart data structure containing at least one product item identifier and a user identifier; determine a probability of completion associated with the shopping cart data structure based at least in part on the at least one product item identifier and the user identifier; determine that the probability of completion is lower than a threshold value and, as a result, identify a data change, and apply the data change to the shopping cart data structure to produce a modified shopping cart data structure; and cause a display on a user device based on the modified shopping cart data structure.

In yet a further aspect, the present application describes a non-transitory computer-readable medium storing processor-executable instructions for processing shopping cart data structures. When executed by one or more processors, the instruction may cause the one or more processors to store a shopping cart data structure in a memory during an active session, the shopping cart data structure containing at least one product item identifier and a user identifier; determine a probability of completion associated with the shopping cart data structure based at least in part on the at least one product item identifier and the user identifier; determine that the probability of completion is lower than a threshold value and, as a result, identify a data change, and apply the data change to the shopping cart data structure to produce a modified shopping cart data structure; and cause a display on a user device based on the modified shopping cart data structure.

For illustrative purposes, specific example embodiments will now be explained in greater detail below in conjunction with the figures.

### Example E-Commerce Platform

In some embodiments, the methods disclosed herein may be performed on or in association with an e-commerce platform. Therefore, an example of an e-commerce platform will be described.

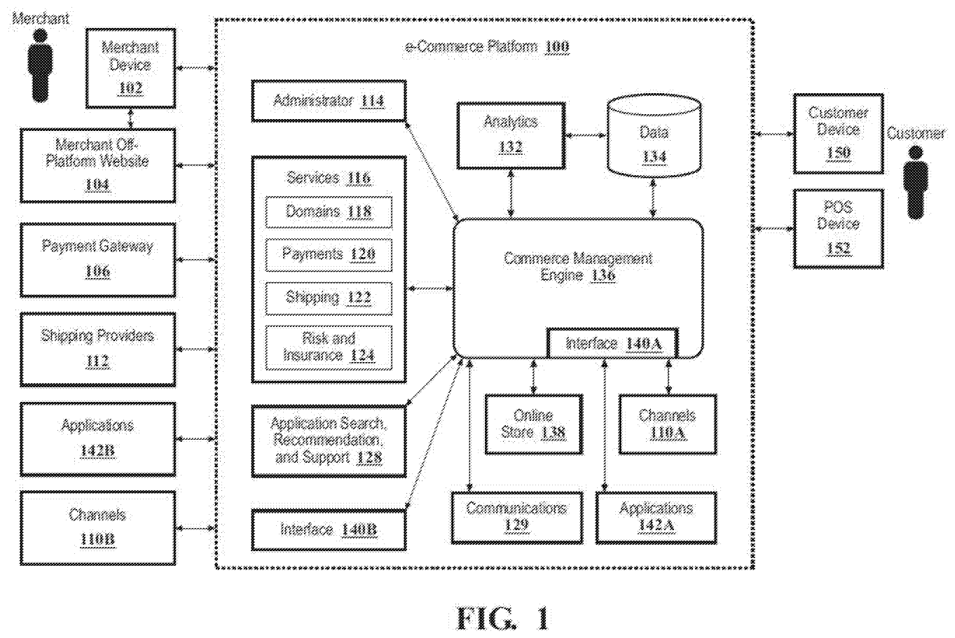

FIG. 1 illustrates an e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers (or “purchasers”) as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

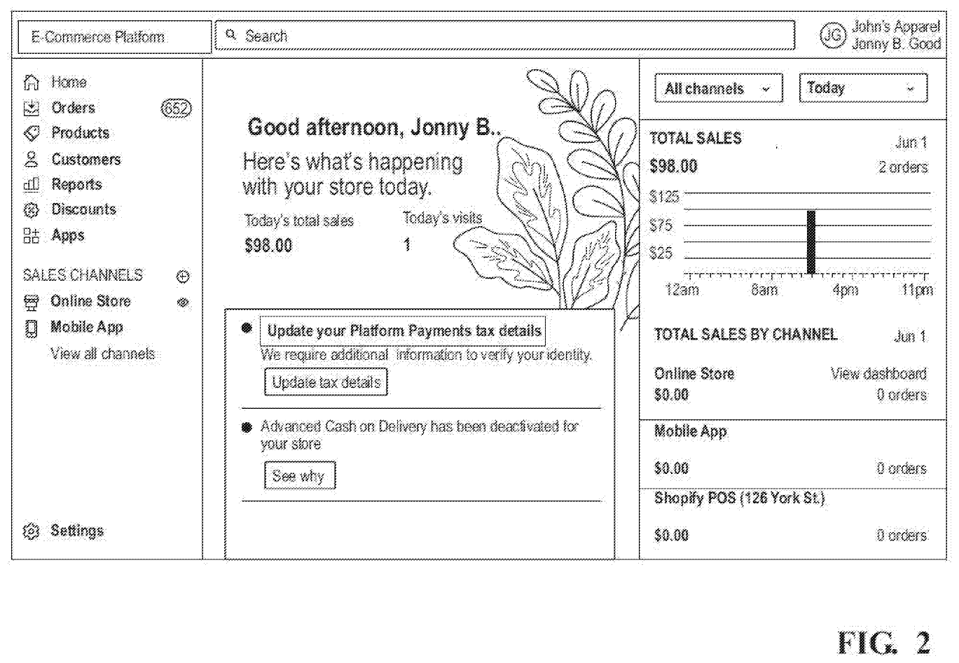

FIG. 2 depicts a non-limiting embodiment for a home page of an administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for the communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a platform payment facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The platform payment facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the platform 100 or by a different party. In some embodiments, an application 142B may be provided by the same party providing the platform 100 or by a different party. The commerce management engine 136 may be configured for flexibility and scalability through portioning (e.g., sharing) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for the platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through an application search, recommendations, and support platform 128 or system. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide the application search, recommendation and support platform 128. The application search, recommendation and support platform 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the lifespan of a cart may be in the order of minutes, carts may be persisted to an ephemeral data store in some cases. However, in many implementations, while the customer session may only last minutes, the merchant and/or customer may wish to have the possibility of returning to a cart built in a previous session. Accordingly, the cart, e.g. the shopping cart data structure populated with product item data and a user identifier, may be stored in persistent memory on the platform 100.

In a typical session, a customer proceeds to checkout at some point after adding one or more items to their shopping cart. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer does not complete the transaction, the e-commerce platform 100 may retain the shopping cart data structure in memory so that the customer may return to the partially-completed cart in a subsequent session (e.g., in an abandoned cart feature).

Checkouts may calculate taxes and shipping costs based on the customer's shipping address. Checkout may delegate the calculation of taxes to a tax component and the calculation of shipping costs to a delivery component. A pricing component may enable merchants to create discount codes. Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Abandoned Shopping Carts

As noted above, an e-commerce platform may permit a user to select a set of items for purchase using a “shopping cart model”. In this model, the platform creates and stores a shopping cart data structure containing information relating to the user, such as a user identifier, and product item identifiers for any product items selected by the user for addition to the data structure. The shopping cart data structure is stored in memory on the platform to track the development of a virtual shopping cart of items over the course of a session with the user. If the user proceeds to the checkout process and completes payment, information from the shopping cart data structure is used in creating an order and to initiate other workflows, such as shipping.

The user may end a session without completing the checkout process and payment. This may occur unintentionally, such as if the user loses connectivity or accidentally closes a browser session or stops operation of an associated application. In some cases, it may occur intentionally, such as if the user is price comparison shopping as between the platform and other sources for the goods, whether online or in traditional bricks-and-mortar retail. In some cases, the user may be monitoring for sales or discounts, may be unsure of the suitability of the purchase, or may decide to delay the purchase for some reason. In any of these situations, when the session ends, the platform maintains the shopping cart data structure to enable the user to return to the uncompleted purchase in the future. The shopping cart data structure may be stored in memory and associated or linked to the user's user profile data on the platform, if any.

The platform may end up storing a large number of abandoned shopping cart data structures so that the associated users can more easily complete the transaction should they return. In some cases, this storage demand can involve a significant memory footprint. In addition, in some cases, depending on the stage of the shopping or checkout processes at which the cart is abandoned, the abandoned shopping cart data structure may have triggered other workflows on the platform, such as inventory and/or shipping API calls, temporary inventory holds, or other problematic “noise” on the platform and/or third-party services.

It would be advantageous to reduce the number of abandoned shopping cart data structures that the platform maintains. One such mechanism for reducing the count of abandoned shopping cart data structures is to increase the likelihood of completion.

In one aspect, the present application provides for an e-commerce platform and/or method that determines a probability of completion, based in part on a shopping cart data structure. If the probability of completion is lower than a threshold level, e.g. the likelihood of abandonment is too high, then the platform identifies and applies a change to the shopping cart data structure that results in an increased probability of completion.

The change to the shopping cart data structure is an automatically applied alteration of the data in the data structure that impacts probability of completion. The change is not presented to the user for approval or selection, like a promotional offer, but rather is applied to the shopping cart data structure based on the calculated probability of completion falling below the threshold level. The change may be any data change to the shopping cart data structure that correlates to higher likelihood of completion.

The determination of probability of completion may be based on a probability model that takes, as inputs, at least the user identifier and at least one product item identifier from the shopping cart data structure. The probability model may, additionally or alternatively, take other inputs, such as, for example, product item identifier quantities or other parameters, merchant completion data, user completion data, etc. In some implementations, the probability model may be developed using a machine learning engine. In some implementations, the platform may provide for completion result feedback to the machine learning engine to continuously refine the probability model.

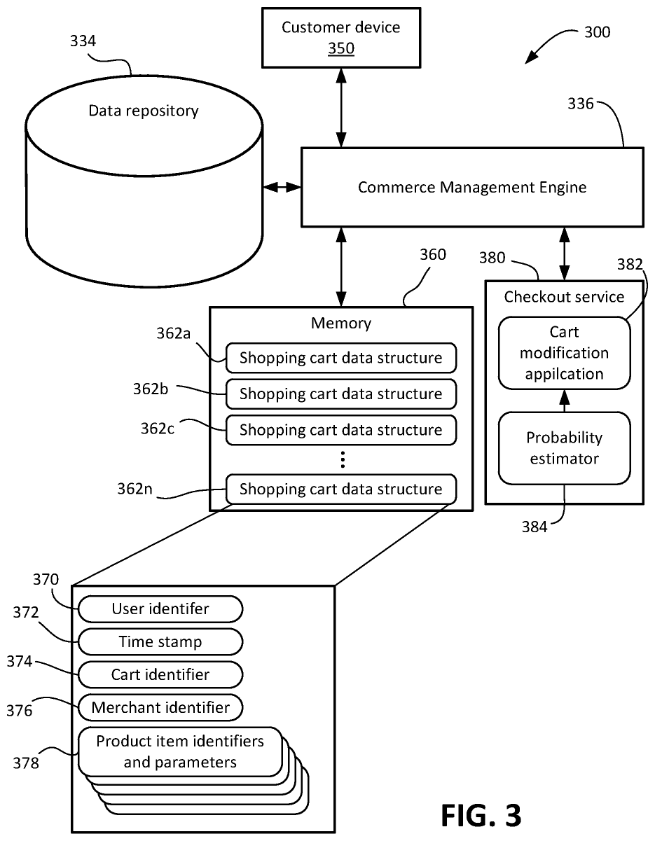

Reference is now made to FIG. 3, which shows, in block diagram form, one simplified example embodiment of an e-commerce platform 300. Not all components of the e-commerce platform 300 are illustrated in this example for ease of exposition. The e-commerce platform 300 in this example includes a commerce management engine (CME) 336 for content management, task automation and data management to enable support and services to a plurality of online stores. The platform 300 may include applications that enable greater flexibility and custom processes to adapt the CME 336 to accommodate a variety of merchant online stores, POS devices, products, and services. The applications may be internal to the e-commerce platform 300 outside the e-commerce platform 300. The commerce management engine 336 may include base or “core” functions of the e-commerce platform 300, as is described above in connection with the e-commerce platform 136 of FIG. 1.

The platform 300 may further include a data repository 334, which may include a variety of types of data, including user/customer data for the platform 300. Customer data may include a user identifier, purchase history, browsing history, credit card details, contact information, shipping information, etc. The data repository 334 may also store merchant data, which may include product item identifiers, historical sales data, inventory data, merchant-specific restrictions or parameters, such as discount offerings, promotional offering details, credit requirements, payment options, shipping restrictions, or other merchant-configurable commerce options. The data repository 334 may be implemented using more than one data repository. The data repository 334 may be implemented as a distributed database, or using mirrored/redundant storage. The data repository 334 may be configured as a searchable database, relational database, or using any other suitable data storage model.

The platform 300 in this example further includes memory 360. The memory 360 may be implemented within the data repository 334 in some examples or may be a separate memory. The memory 360 may be a temporary or volatile memory in some implementations.

The memory 360 stores, among other information, shopping cart data structures 362 (shown individually as 362a, 362b, 362c, . . . , 362n). The shopping cart data structures 362 each contain data relating to a store browsing session by a user. In this example, the shopping cart data structure 362n includes a user identifier 370. The user identifier 370 may include a unique user identifier that pinpoints a registered user record in the data repository 334. In some cases, the user identifier 370 may be a unique identifier for an anonymous user that has not, yet, provided login credentials to authenticate identity. The anonymous user may need to provide login credentials or create a user profile that generates a new user identifier and user record prior to completing a purchase transaction, in some implementations.

The shopping cart data structure 362n may further include a cart identifier 374, since any given user may have more than one partially completed cart. For example, a user may have a shopping cart data structure in relation to a specific merchant/store and a different shopping cart data structure in connection with a different merchant/store, particularly in the case where the user may be comparison shopping across merchants. The cart identifier 374 identifies and corresponds to the shopping cart data structure 362n.

The shopping cart data structure 362n may further include a time stamp 372 indicating a last-update time in relation to the content of the shopping cart data structure 362n, and a merchant identifier 376 uniquely identifying the merchant store within which the shopping cart data structure 362n has been built.

The shopping cart data structure 362n may also include one or more product item identifiers 378. The product item identifiers 378 correspond to items offered by the merchant. The product item identifiers 378 may include a product code or SKU and may also include other parameters, such as quantity, size, colour, etc., to the extent such parameters are not already reflected in the product code or SKU. The shopping cart data structures may be initially created for each session initiated by a user in connection with a specific merchant/store. When initially created, the data structure may include the user identifier 370, cart identifier 374, time stamp 372, and merchant identifier 376, but contain no product identifiers 378. As the user browses the merchant interface, for example using a customer device 350, the user may select items to be added to the cart. Selection of an item may cause the platform 300 to add the corresponding product identifier 378 to the shopping cart data structure 362 associated with that user's session. Items may also be removed from the cart during a session, resulting in the platform 300 deleting the corresponding product identifier 378 from the shopping cart data structure 362. In some cases, the platform 300 may track, for example using the shopping cart data structure 362, items that have been removed from the cart.

The e-commerce platform 300 may further include a checkout service 380. The checkout service 380 may be implemented as one of the common services 116 (FIG. 1) provided by the platform 300 or may be implemented as an application 142A, 142B (FIG. 1). The checkout service 380 may also be partly or wholly implemented within a merchant-specific online store 138 (FIG. 1) in some configurations. Although in this example, the checkout service 380 is illustrated as being implemented within the e-commerce platform 300, it will be appreciated that in some implementations the checkout service 380 may be external to the e-commerce platform 300. In some cases, the checkout service 380 may be implemented within a single online store and in some cases the checkout service 380 may be a standalone external service available to the e-commerce platform 300 and on-line stores for various merchants.

The checkout service 380 provides the functionality for the phases of a checkout process. The checkout process may generally feature three phases, although in some implementations phases may be combined or may be skipped if configured to use default settings. The three phases may include (1) item review phase, (2) shipping information phase, and (3) payment phase.

The checkout service 380 in this example may include a cart modification application 382. The cart modification application 382 includes processor-executable code that, when executed by one or more processors, causes the platform 300 to determine the probability of completion for a specific shopping cart data structure 362 and, if that probability is below a threshold level, to identify a data change and modify the shopping cart data structure 362 by applying that data change. While the cart modification application 382 is shown as part of the checkout service 380 in this example, it may be implemented elsewhere in the platform 300 and is not necessarily used solely in connection with the checkout process.

The checkout service 380 in this example may further include a completion probability estimator 384 to analyze a shopping cart data structure 362 and determine a probability of completion. The completion probability estimator 384 may use a probability model that takes a plurality of data inputs and outputs a probability of completion for a given shopping cart data structure 362. The completion probability estimator 384 may obtain data from the data repository 334 as further input to the probability model. The completion probability estimator 384 may be implemented by way of processor-executable software instructions that, when executed by a processor, obtain the necessary data inputs and calculate the probability of completion. While the completion probability estimator 384 is shown as part of the checkout service 380 in this example, it may be implemented elsewhere in the platform 300 and is not necessarily used solely in connection with the checkout process.

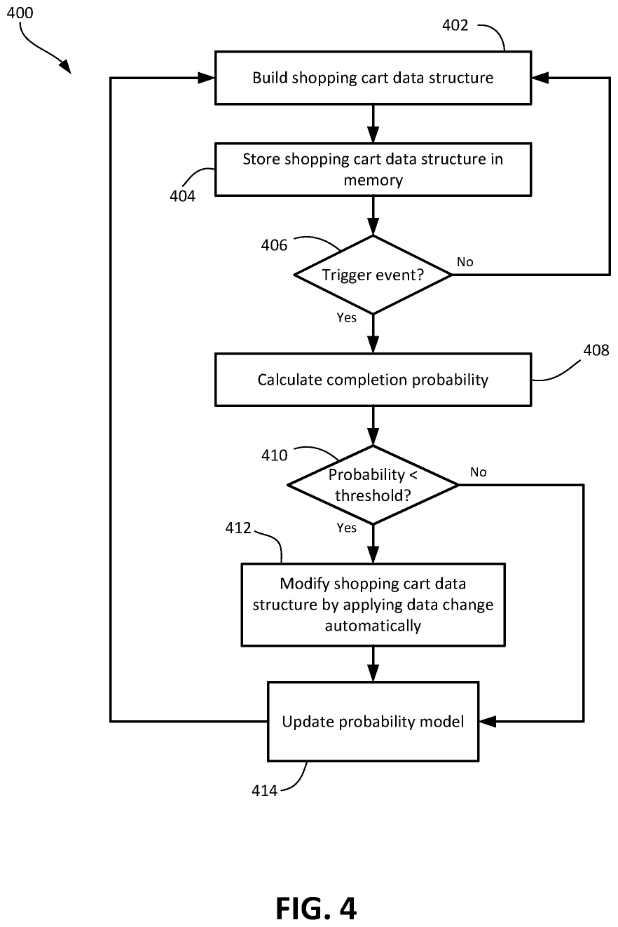

Reference will now be made to FIG. 4, which shows, in flowchart form, one example method 400 of reducing memory consumption due to abandoned data structures in an e-commerce platform. The method 400 may be implemented by way of processor-executable instructions that, when executed by a processor, cause the processor to carry out the described operations. The operations may involve memory access functions, signal or data reception or transmission functions, display operations, and other operations involving components coupled to the processor. The instructions may be embodied in one or more software modules, applications, routines, etc.

The method 400 includes building a shopping cart data structure in operation 402. The shopping cart data structure may be a data structure having prescribed fields, such as for cart identifier, user identifier, or other parameters. The data structure may include a variable sized field for containing product item identifier data. The shopping cart data structure is stored in memory in operation 404. The memory may be a temporary memory location used during an active session, or may be a permanent memory location in, for example, a suitable data repository. In some cases, the shopping cart data structure may be stored in one memory during an active session and, if the session is abandoned, then the shopping cart data structure may be moved to a different memory for storage as an abandoned shopping cart data structure.

In operation 406, the platform determines whether a trigger event has occurred. The trigger event causes the platform to carry out the remaining operations of the method 400 to determine whether to automatically modify the shopping cart data structure or not and, if it is determined that the shopping card data structure should be so modified, then to identify and apply a change to the shopping cart data structure. Example trigger events may include detecting transition to a phase of the checkout process. For instance, a trigger event may be receiving user selection of a checkout icon or symbol, which may equate to initiation of a checkout process. The trigger event may be receiving confirmation of the items in the cart during the item review phase and/or a request to transition to the shipping information phase of the checkout process. The trigger event may be receiving shipping information or confirmation of the shipping information and a request to initiate the payment phase of the checkout process. In some cases, more than one trigger event may cause the method 400 to be carried out. In some cases, a trigger event may be detecting any change in the shopping cart data structure, such as addition of a product item identifier, deletion of a product item identifier, modification of an item quantity, or other such changes.

If a trigger event is detected in operation 406, then in operation 408 the platform determines the probability of completion based on the current shopping cart data structure. The probability of completion is a calculation of the probability that the current session will conclude with a completed purchase. The inputs to that calculation include at least the user identifier and at least one product item identifier from the shopping cart data structure. In some cases, the calculation includes one or more other inputs, such as a merchant identifier, user purchase history data corresponding to the user identifier, merchant sale history data corresponding to the product item identifiers, platform-level completion history data, session data, or other available data sources. Further discussion of the determination of probability of completion is provided below. Although the present description makes reference to a probability of completion, it will be understood that the platform could equivalently determine a probability of abandonment, i.e. probability of non-completion (abandonment being the complementary event to completion).

The user purchase history data may include history of purchases completed, which may include data regarding purchase of the same or similar product items or data regarding purchases from the same merchant. The merchant sale history data may include sales data relating to the product item identifiers in the shopping cart data structure. The session data may include data such as number of items added to or removed from the cart, the length of the session, the number of parameter changes made to product items identifiers, etc. The product item identifiers and parameters may include whether the items are on sale, the total value of items, whether there are discounts applied by merchant rule, cross-merchant sales data for the items, etc.

In operation 410, the platform assesses whether the calculated probability of completion is below a threshold value. The threshold value may be set to any suitable level depending on the desired level of sensitivity, i.e. how aggressively the platform should automatically attempt to modify shopping carts to decrease incidents of abandonment. If the determined probability of completion is sufficiently high, then no action is taken to modify the shopping cart data structure and the checkout process or shopping process continues as per normal. Nevertheless, the platform continues to monitor to determine whether the session concludes in an abandoned shopping cart data structure or not. The platform then, in operation 414, updates the probability model based on the outcome, i.e. based on whether the shopping cart data structure resulted in a completed purchase or in an abandoned shopping cart data structure.

If the probability of completion determined in operation 408 is found to be below the threshold value in operation 410, then in operation 412 the platform identifies a data change and applies that data change to modify the shopping cart data structure, thereby producing a modified shopping cart data structure. The data change may include any change to the shopping cart data structure, such as to the product item identifiers and associated parameters. The data change may be identified based on it being correlated to an increased probability of completion. Example data changes may include one or more of adding a product item at a discounted cost or at no cost, applying a discount in pricing to one or more of the product items, reducing the cost of shipping, adding additional loyalty program points, and/or other changes that may correlate to an improved probability of completion.

This modified shopping cart data structure is visible to the user/customer through the customer device. For example, depending on the phase of the checkout process, the data change may be visible in the item listing, in the total pricing, in the order summary, or other displayed content in a graphical user interface on the customer device. It is not, however, presented as an option or “incentive”, but rather is automatically applied to the shopping cart data structure in an attempt to improve probability of completion.

The platform monitors to determine whether the session concludes in an abandoned shopping cart data structure or not. It then, in operation 414, updates the probability model based on the outcome, i.e. based on whether the modified shopping cart data structure resulted in a completed purchase or in an abandoned shopping cart data structure.

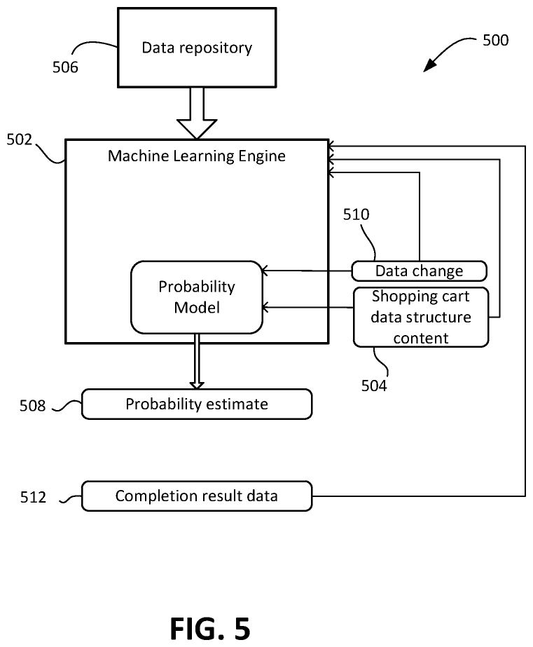

Reference will now be made to FIG. 5, which shows a diagrammatic illustration of a system 500 for determining a probability of completion. The system 500 in this example may be implemented on one or more computing device having one or more processors and suitable memory on which is stored computer-executable instructions implementing the functional components of the system 500. In this example, the system 500 includes a machine learning engine 502. The machine learning engine 502 may include a plurality of inputs, including user identifier and product item identifiers from the shopping cart data structure. The machine learning engine 502, once trained, is one example of a probability model. In some examples, the machine learning engine 502 may take the plurality of inputs and use a large set of weights to process the inputs in a non-linear function to produce a probability of completion, i.e. a probability that the shopping cart data structure will result in a completed payment and order instead of an abandoned shopping cart data structure. The machine learning engine 502 may, through feedback, adjust those weights from time to time. In some example implementations, the machine learning engine 502 may include one or more layers of convolution and/or pooling of selected inputs.

The machine learning engine 502 receives as input signals the contents of the shopping cart data structure 504. This input includes at least the user identifier and the product item identifier(s). The machine learning engine 502 may also receive (or retrieve) as input signals data from a data repository 506. The data from the data repository 506 may be retrieved based on the contents of the shopping cart data structure 504. For example, based on the user identifier in the shopping cart data structure 504, a user record within the data repository 506 may be retrieved. The user record may indicate purchase history, including product items purchased, product items purchased together, time between orders, quantities of items purchased in one transaction, pricing of those items purchase, whether discounts, free shipping, loyalty program points, or other such incentives were involved in prior purchases, and/or which merchants those purchases were from, among other data. Any one or more of those input signals may be part of the data input to the machine learning engine 502.

As another example, based on the merchant identifier in the shopping cart data structure 504, a merchant record within the data repository 506 may be retrieved. The merchant record may provide historical sales data for the merchant, including pricing data for individual product items, correlation data for orders involving more than one product item, historical cart abandonment statistics, or other such data.

Other data may also be retrieved from the data repository 506 and input to the machine learning engine 502. Example data includes cross-merchant cart abandonment data and platform-wide product item sales and pricing data, including same-sale correlation data.

In an initial training phase, the machine learning engine 502 may take a large number of such inputs. Over time as the probability model is refined the machine learning engine 502 may prune a number of the inputs on the basis that the engine 502 determines that those inputs have negligible or no relevance to the output. One pruning mechanism is to assign a zero or near-zero weight to a number of inputs such that they are no longer deemed useful to retrieve. Other feature selection and/or pruning techniques may be used. Accordingly, post-initial-training the number of inputs retrieved from the data repository 506 may be more limited, depending on the probability model developed.

The machine learning engine 502 produces a probability estimate 508. The probability estimate 508 reflects the estimated probability that the shopping cart data structure 504 will result in a completed purchase order as opposed to an abandoned shopping cart data structure.

In some implementations, the machine learning engine 502 may also receive a data change 510 as an input. Although illustrated separately from the contents of the shopping cart data structure 504 for ease of explanation, it will be appreciated that the data change 510 is a change to the contents of the shopping cart data structure 504 that, when applied to the shopping cart data structure, results in a modified shopping cart data structure. In the case where the machine learning engine 502 is evaluating a data change 510, the machine learning engine 502 receives data from the modified shopping cart data structure, i.e. the shopping cart data structure 504 modified by the data change 510, and possibly input signals from the data repository 506. The machine learning engine 502 then produces the probability estimate 508 for the modified shopping cart data structure.

Once a session is finished, the system 500 feeds completion data 512 back to the machine learning engine 502, which may consequently adjust its internal weights to refine the probability model. The completion data 512 may be a binary signal indicating whether the transaction resulted in a completed order or an abandoned shopping cart data structure. That completion data 512, together with the shopping cart data structure content and any other input signals relevant to the session, may be used by the machine learning engine 502 to refine the probability model.

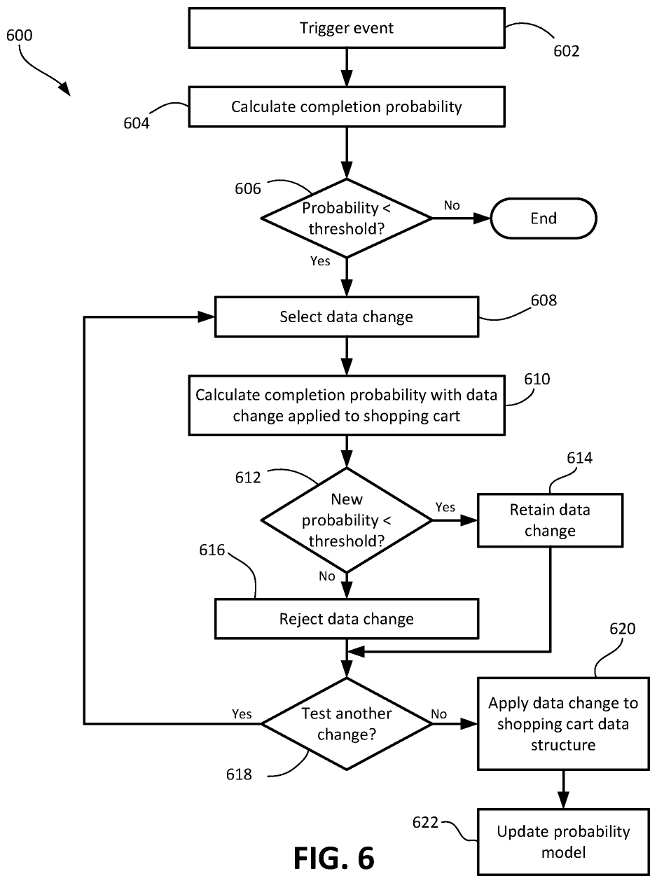

Reference is now made to FIG. 6, which shows, in flowchart form, another example method 600 for reducing memory consumption due to abandoned data structures in an e-commerce platform. The method 600 may be implemented by way of processor-executable instructions that, when executed by a processor, cause the processor to carry out the described operations. The operations may involve memory access functions, signal or data reception or transmission functions, display operations, and other operations involving components coupled to the processor. The instructions may be embodied in one or more software modules, applications, routines, etc.

The method 600 begins with detection of a trigger event in operation 602. As discussed above, there may be one trigger event, such as selection of a checkout icon, or there may be multiple potential trigger events. In some cases, the method 600 may be carried out more than once during a single session due to the detection of multiple triggers. Example trigger events include detecting selection of a first phase of a checkout process (e.g. an item or order review phase), detecting selection of a second phase of a checkout process (e.g. a shipping information phase), detecting selection of a third phase of a checkout process (e.g. a payment information phase), or detection of pre-checkout or editing activity in connection with the shopping cart data structure (e.g. addition, deletion, or modification of items in the shopping cart data structure).

In operation 604, a completion probability is determined. In some cases, the completion probability may be a probability calculation based on a probability model. The probability model may take as inputs a number of signals, including for example one or more of the contents of the shopping cart data structure, the user identity, the merchant identity, user history data, merchant history data, cross-merchant completion data, session characteristics, etc. The calculated completion probability may then be compared to a threshold value in operation 606. The threshold value may be set to any suitable value depending on how aggressive an implementation is intended to be in terms of automatically modifying shopping carts. In a case where automated modification is intended to be infrequent, the threshold value may be set low, such as at 0.4 or 0.5; however, if automated modification is intended to be more aggressive, then the threshold value may be set higher, such as at 0.8 or 0.9, meaning that the method 600 would still be carried out for carts that are almost 80 or 90% likely to result in a completed purchase.

If in operation 606 the completion probability is determined to be below the threshold value, then in operation 608 a data change is selected. The data change is a change to the shopping cart data structure. It may include addition of a product item, a discount to pricing of a product item, a discount to shipping costs, addition of loyalty points, or other modifications to the contents of the shopping cart data structure. Those content changes may include insertion of a new product item identifier, increase in a product item count value, change in a product item parameter, change in a shipping cost parameter, or change in a loyalty points parameter, as examples. The set of possible data changes may be prescribed by the platform. In some cases, the set of possible data changes may be prescribed by the merchant with which the shopping cart data structure is associated. For example, the merchant may only enable certain data changes.

The selection of the data change may be based on one or more input signals, including the contents of the shopping cart data structure, the user identity, the user history, or other such signals. In some cases, the selection of the data change may be based on iterating through each data change option in a set of prescribed data change options as further described below. In some cases, the data change may be based on user purchase history, e.g. whether previous such data changes have resulted in a purchase completion for this user, or whether the user characteristics match an enabling condition for a particular data change, e.g. loyalty points collector. In some cases, data changes are enabled or available based on the product item identifiers. For example, only certain categories of product items may be suitable for a buy-one-get-one (BOGO) discount or free offer. In other cases, the total value of the cart may enable certain data changes not otherwise available for lower value carts.

The data change results in a modified shopping cart data structure. At this stage of the method 600, the modified shopping cart data structure may be stored in temporary memory as a potential modified shopping cart data structure, rather than overwriting the shopping cart data structure stored in memory in association with the active session.

In operation 610, the completion probability is determined again, but with regard to the modified shopping cart data structure. The inputs to the probability model remain the same, but for the data change to the content of the shopping cart data structure.

In operation 612, the newly-calculated completion probability is compared to the previously-calculated completion probability. In some embodiments in which more than one data change is evaluated, the comparison may be with the original completion probability or with the highest completion probability identified so far. For example, in a first iteration of the method 600 the previously-calculated completion probability is the probability associated with the shopping cart data structure; whereas in subsequent iterations the completion portability may be a probability determined for a modified shopping cart data structure that implements a different data change. In this regard, the platform may store an optimal modified shopping cart data structure based on the highest completion probability. As new data changes are evaluated, if the completion probability is higher than the highest yet calculated, then that new data change results in overwriting the optimal modified shopping cart data structure.

Operation 612 may be based on a straight comparison in some implementations, i.e. whether the newly-calculated probability is greater than the original probability. In some other implementations, the comparison may be based on detecting at least a preset minimum improvement in probability. For example, operation 612 may include subtracting the original probability from the current probability and determining whether the different exceeds a minimum value.

If the new probability is greater than (or greater than by more than a minimum improvement value) the previously-calculated probability, then in operation 614 the data change is accepted. Otherwise, in operation 616, the data change is rejected. As noted above, in some cases, this may be implemented by storing the current modified shopping cart data structure as an optimal shopping cart data structure that overwrites the previously-stored optimal shopping cart data structure.

In operation 618, the platform may determine whether to test an alternative data change. In some embodiments, only a single data change is evaluated based on the selection of that data change in operation 608. In some other embodiments, two or more data changes are evaluated in turn to determine which of the data changes results in the best improvement in probability of completion.

In one variation, the platform evaluates each data change on its own and in combination with one or more other data changes, such that more than one data change may be made to produce the modified shopping cart data structure.

Once the platform has finished evaluating data changes, in operation 620 the data change, if any is selected in operation 614, is applied to the shopping cart data structure of the active session. This may include, in some examples, overwriting the shopping cart data structure in memory with the optimal shopping cart data structure, thereby implementing the data change(s) found to be optimal in operations 608-618.

Application of the data change(s) is reflected in an output to a GUI on a user device. For example, if taking place during a first phase of a checkout process, the data change may be reflected in the item list displayed, or in discounts or other order features displayed. Notably, the application is not conditional on presenting the data change as an option in a message, pop-up or other user interaction mechanism, or receiving a user input selection approving the data change. Instead, the data change is applied automatically without obtaining user pre-approval. Nevertheless, the user may, in some cases, make modifications to the shopping cart data structure following the application of the data change including, in some examples, undoing the data change.

In operation 622, once the session is complete, resulting in either a completed purchase event or an abandoned shopping cart data structure, the probability model may be updated. In some cases this involves feeding the results data back to a machine learning engine together with the input data, including the modified shopping cart data structure.

It will be appreciated that some of the operations described in the above methods may be performed in a different order or may be performed in parallel or in combination with other operations without materially changing the functioning of the methods.

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g. Long Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method for processing shopping cart data structures, the method comprising:
storing a shopping cart data structure in memory during an active session, the shopping cart data structure containing at least one product item identifier and a user identifier;
determining a probability of completion associated with the shopping cart data structure based at least in part on the at least one product item identifier and the user identifier;
determining that the probability of completion is lower than a threshold value and, as a result,
identifying a data change, and
applying the data change to the shopping cart data structure to produce a modified shopping cart data structure; and
causing a display on a user device based on the modified shopping cart data structure.

2. The computer-implemented method of claim 1, further comprising detecting a trigger event prior to determining the probability of completion.

3. The computer-implemented method of claim 2, wherein the trigger event includes receiving an input to initiate a checkout process.

4. The computer-implemented method of claim 2, wherein the trigger event includes receiving an input causing a change in content of the shopping cart data structure.

5. The computer-implemented method of claim 4, wherein the change in the content of the shopping cart data structure includes adding a further product item identifier to the shopping cart data structure.

6. The computer-implemented method of claim 1, wherein determining the probability of completion is based on a probability model and wherein the probability model has inputs that include the at least one product item identifier, the user identifier, and at least one of user history data or merchant history data.

7. The computer-implemented method of claim 6, wherein the probability model is generated by a machine learning engine, and wherein the method further includes determining a completion result and providing the completion result to the machine learning engine to update the probability model.

8. The computer-implemented method of claim 1, wherein identifying a data change includes selecting the data change from among a plurality of predefined data changes.

9. The computer-implemented method of claim 8, wherein selecting includes determining a respective probability of completion associated with a modified shopping cart data structure for each of the plurality of predefined data changes and selecting the data change based on it having a highest associated respective probability of completion.

10. The computer-implemented method of claim 8, wherein the plurality of predefined data changes includes a set of data changes filtered to exclude at least some data changes based on a merchant-defined restriction parameter.

11. The computer-implemented method of claim 1, wherein applying the data change to the shopping cart data structure includes insertion of a new product item identifier, increase in a product item count, change in a product item parameter, change in a shipping cost parameter, or change in a loyalty points parameter.

12. The computer-implemented method of claim 1, wherein identifying a data change includes determining a new probability of completion associated with the modified shopping cart data structure based at least in part on the at least one product item identifier, the user identifier, and the data change, and determining that the new probability of completion is greater than the probability of completion by at least a minimum value.

13. The computer-implemented method of claim 1, further comprising completing a transaction regarding the modified shopping cart data structure and, as a result, deleting the modified shopping cart data structure from the memory.

14. A system for processing shopping cart data structures, the system comprising:
a processor; and
a storage medium storing computer-executable instructions that, when executed by the processor, are to cause the processor to:
store a shopping cart data structure in a memory during an active session, the shopping cart data structure containing at least one product item identifier and a user identifier;
determine a probability of completion associated with the shopping cart data structure based at least in part on the at least one product item identifier and the user identifier;
determine that the probability of completion is lower than a threshold value and, as a result,
identify a data change, and
apply the data change to the shopping cart data structure to produce a modified shopping cart data structure; and
cause a display on a user device based on the modified shopping cart data structure.

15. The system of claim 14, wherein the computer-executable instructions, when executed by the processor, are to further cause the processor to detect a trigger event prior to determining the probability of completion.

16. The system of claim 15, wherein the trigger event includes receiving an input to initiate a checkout process.

17. The system of claim 15, wherein the trigger event includes receiving an input causing a change in content of the shopping cart data structure.

18. The system of claim 17, wherein the change in the content of the shopping cart data structure includes adding a further product item identifier to the shopping cart data structure.

19. The system of claim 14, wherein the computer-executable instructions, when executed by the processor, are to further cause the processor to determine the probability of completion based on a probability model and wherein the probability model has inputs that include the at least one product item identifier, the user identifier, and at least one of user history data or merchant history data.

20. The system of claim 19, further comprising a machine learning engine configured to generate the probability model, and wherein the computer-executable instructions, when executed by the processor, are to further cause the processor to determine a completion result and provide the completion result to the machine learning engine to update the probability model.

21. The system of claim 14, wherein the computer-executable instructions, when executed by the processor, are to further cause the processor to identify a data change by selecting the data change from among a plurality of predefined data changes.

22. The system of claim 21, wherein the computer-executable instructions, when executed by the processor, are to further cause the processor to select the data change by determining a respective probability of completion associated with a modified shopping cart data structure for each of the plurality of predefined data changes and selecting the data change based on it having a highest associated respective probability of completion.

23. The system of claim 21, wherein the plurality of predefined data changes includes a set of data changes filtered to exclude at least some data changes based on a merchant-defined restriction parameter.

24. The system of claim 14, wherein the computer-executable instructions, when executed by the processor, are to further cause the processor to apply the data change to the shopping cart data structure by causing insertion of a new product item identifier, increase in a product item count, change in a product item parameter, change in a shipping cost parameter, or change in a loyalty points parameter.

25. The system of claim 14, wherein the computer-executable instructions, when executed by the processor, are to further cause the processor to identify a data change by determining a new probability of completion associated with the modified shopping cart data structure based at least in part on the at least one product item identifier, the user identifier, and the data change, and determining that the new probability of completion is greater than the probability of completion by at least a minimum value.

26. The system of claim 14, the computer-executable instructions, when executed by the processor, are to further cause the processor to complete a transaction regarding the modified shopping cart data structure and, as a result, delete the modified shopping cart data structure from the memory.

27. A non-transitory computer-readable medium storing processor-executable instructions for processing shopping cart data structures, wherein the instructions, when executed by one or more processors, are to cause the one or more processors to:
store a shopping cart data structure in a memory during an active session, the shopping cart data structure containing at least one product item identifier and a user identifier;
determine a probability of completion associated with the shopping cart data structure based at least in part on the at least one product item identifier and the user identifier;
determine that the probability of completion is lower than a threshold value and, as a result,
identify a data change, and
apply the data change to the shopping cart data structure to produce a modified shopping cart data structure; and
cause a display on a user device based on the modified shopping cart data structure.
